(19) United States
(12) Patent Application Publication
(10) Pub. No.: US 2009/0231401 A1
(43) Pub. Date: Sep. 17, 2009

(54) PRINTER WITH GAS BUBBLE OCCLUSION RESISTANT CONDUITS

(75) Inventors: John Douglas Peter Morgan, Balmain (AU); Miao Wang, Balmain (AU); Patrick John McAuliffe, Balmain (AU); Kia Silverbrook, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/046,449

(22) Filed: Mar. 12, 2008

(51) Int. Cl. B41J 2/17

(52) U.S. Cl. 347/92

(57) ABSTRACT

An inkjet printer with a printhead and a conduit connected to the printhead. The conduit defines a flow path for the printing fluid and has an internal cross section configured such that the surface tension of printing fluid within it favors gas bubble growth along the conduit length over radial bubble growth that would fully occlude the flow path.

### FIELD OF THE INVENTION

The present invention relates to inkjet printers and in particular, the fluidic system for supplying the printhead with ink.

### CROSS REFERENCES TO RELATED APPLICATIONS

Various methods, systems and apparatus relating to the present invention are disclosed in the following US Patents/Patent Applications filed by the applicant or assignee of the present invention:

| | | | | | | |
|---|---|---|---|---|---|---|
| 6276850 | 6520631 | 6158907 | 6539180 | 6270177 | 6405055 | 6628430 |
| 6835135 | 6626529 | 6981769 | 7125338 | 7125337 | 7136186 | 7286260 |
| 7145689 | 7130075 | 7081974 | 7177055 | 7209257 | 6443555 | 7161715 |
| 7154632 | 7158258 | 7148993 | 7075684 | 10/943905 | 10/943906 | 10/943904 |
| 10/943903 | 10/943902 | 6966659 | 6988841 | 7077748 | 7255646 | 7070270 |
| 7014307 | 7158809 | 7217048 | 11/225172 | 11/255942 | 11/329039 | 11/329040 |
| 7271829 | 11/442189 | 11/474280 | 11/483061 | 11/503078 | 11/520735 | 11/505858 |
| 11/525850 | 11/583870 | 11/592983 | 11/592208 | 11/601828 | 11/635482 | 11/635526 |
| 10/466440 | 7215441 | 11/650545 | 11/653241 | 11/653240 | 7056040 | 6942334 |
| 11/706300 | 11/740265 | 11/737720 | 11/739056 | 11/740204 | 11/740223 | 11/753557 |
| 11/750285 | 11758648 | 11/778559 | 11834634 | 11/838878 | 11845669 | 12015407 |
| 12/017331 | 12030823 | 6799853 | 7237896 | 6749301 | 10/451722 | 7137678 |
| 7252379 | 7144107 | 10/503900 | 10/503898 | 10/503897 | 7220068 | 7270410 |
| 7241005 | 7108437 | 7140792 | 10/503922 | 7224274 | 10/503917 | 10/503918 |
| 10/503925 | 10/503927 | 10/503928 | 10/503929 | 10/503885 | 7195325 | 7229164 |
| 7150523 | 10/503889 | 7154580 | 6906778 | 7167158 | 7128269 | 6688528 |
| 6986613 | 6641315 | 7278702 | 10/503891 | 7150524 | 7155395 | 6915140 |
| 6999206 | 6795651 | 6883910 | 7118481 | 7136198 | 7092130 | 6786661 |
| 6808325 | 10/920368 | 10/920284 | 7219990 | 10/920283 | 6750901 | 6476863 |
| 6788336 | 6322181 | 6597817 | 6227648 | 6727948 | 6690419 | 10/470947 |
| 6619654 | 6969145 | 6679582 | 7328896 | 6568670 | 6866373 | 7280247 |
| 7008044 | 6742871 | 6966628 | 6644781 | 6969143 | 6767076 | 6834933 |
| 6692113 | 6913344 | 6727951 | 7128395 | 7036911 | 7032995 | 6969151 |
| 6955424 | 6969162 | 10/919249 | 6942315 | 11/006577 | 7234797 | 6986563 |
| 7295211 | 11/045442 | 7286162 | 7283159 | 7077330 | 6196541 | 7303257 |
| 11/185725 | 7226144 | 11/202344 | 7267428 | 11/248423 | 11/248422 | 7093929 |
| 11/282769 | 11/330060 | 11/442111 | 7290862 | 11/499806 | 11/499710 | 6195150 |
| 11749156 | 11782588 | 11/854435 | 11/853817 | 11/935958 | 11924608 | 6362868 |
| 11970993 | 12031526 | 6831681 | 6431669 | 6362869 | 6472052 | 6356715 |
| 6894694 | 6636216 | 6366693 | 6329990 | 6459495 | 6137500 | 6690416 |
| 7050143 | 6398328 | 7110024 | 6431704 | 6879341 | 6415054 | 6665454 |
| 6542645 | 6486886 | 6381361 | 6317192 | 6850274 | 09/113054 | 6646757 |
| 6624848 | 6357135 | 6271931 | 6353772 | 6106147 | 6665008 | 6304291 |
| 6305770 | 6289262 | 6315200 | 6217165 | 6496654 | 6859225 | 6924835 |
| 6647369 | 6943830 | 09/693317 | 7021745 | 6712453 | 6460971 | 6428147 |
| 6416170 | 6402300 | 6464340 | 6612687 | 6412912 | 6447099 | 6837567 |
| 6505913 | 7128845 | 6733684 | 7249108 | 6566858 | 6331946 | 6246970 |
| 6442525 | 09/517384 | 09/505951 | 6374354 | 7246098 | 6816968 | 6757832 |
| 6334190 | 6745331 | 7249109 | 7197642 | 7093139 | 10/636263 | 10/636283 |
| 10/866608 | 7210038 | 10/902883 | 10/940653 | 10/942858 | 11/706329 | 11/757385 |
| 11/758642 | 7119836 | 7283162 | 7286169 | 10/636285 | 7170652 | 6967750 |
| 6995876 | 7099051 | 7172191 | 7243916 | 7222845 | 11/239232 | 7285227 |
| 7063940 | 11/107942 | 7193734 | 7086724 | 7090337 | 7278723 | 7140717 |
| 11/190902 | 11/209711 | 7256824 | 7140726 | 7156512 | 7186499 | 11/478585 |
| 11/525862 | 11/540574 | 11/583875 | 11/592181 | 6750944 | 11/599336 | 7291447 |
| 11744183 | 11/758646 | 11/778561 | 11/839532 | 11/838874 | 11/853021 | 11/869710 |
| 11/868531 | 11927403 | 11951960 | 12019556 | 10/636225 | 6985207 | 6773874 |
| 6650836 | 7324142 | 10/636224 | 7250975 | 7295343 | 6880929 | 7236188 |
| 7236187 | 7155394 | 10/636219 | 10/636223 | 7055927 | 6986562 | 7052103 |
| 7312845 | 10/656281 | 10/656791 | 10/666124 | 10/683217 | 7289142 | 7095533 |
| 6914686 | 6896252 | 6820871 | 6834851 | 6848686 | 6830246 | 6851671 |
| 10/729098 | 7092011 | 7187404 | 10/729159 | 10/753458 | 6878299 | 6929348 |
| 6921154 | 10/780625 | 10/804042 | 6913346 | 10/831238 | 10/831237 | 10/831239 |
| 10/831240 | 10/831241 | 10/831234 | 10/831233 | 7246897 | 7077515 | 10/831235 |
| 10/853336 | 10/853117 | 10/853659 | 10/853681 | 6913875 | 7021758 | 7033017 |
| 7161709 | 7099033 | 7147294 | 7156494 | 11/012024 | 11/011925 | 7032998 |
| 7044585 | 7296867 | 6994424 | 11/006787 | 7258435 | 7097263 | 7001012 |
| 7004568 | 7040738 | 7188933 | 7027080 | 7025446 | 6991321 | 7131715 |
| 7261392 | 7207647 | 7182435 | 7097285 | 7331646 | 7097284 | 7083264 |
| 7147304 | 7232203 | 7156498 | 7201471 | 11/501772 | 11/503084 | 11/513073 |
| 7210764 | 11/635524 | 11/706379 | 11/730386 | 11/730784 | 11/753568 | 11/782591 |
| 11/859783 | 12015243 | 12037069 | 6710457 | 6775906 | 6507099 | 7221043 |
| 7107674 | 7154172 | 11/442400 | 7247941 | 11/736540 | 7307354 | 11/940304 |
| 6530339 | 6631897 | 6851667 | 6830243 | 6860479 | 6997452 | 7000913 |
| 7204482 | 11/212759 | 11/281679 | 11/730409 | 6238044 | 6425661 | 11/003786 |
| 7258417 | 7293853 | 7328968 | 7270395 | 11/003404 | 11/003419 | 7334864 |
| 7255419 | 7284819 | 7229148 | 7258416 | 7273263 | 7270393 | 6984017 |
| 11/003699 | 11/071473 | 7156497 | 11/601670 | 11748482 | 11/778563 | 11/779851 |
| 11/778574 | 11/853816 | 11/853814 | 11/853786 | 11/872037 | 11/856694 | 11965703 |
| 11971170 | 12023011 | 12036896 | 11/003463 | 11/003701 | 11/003683 | 11/003614 |
| 7284820 | 7341328 | 7246875 | 7322669 | 11/764760 | 11853777 | 11955354 |
| 12022994 | 11/293800 | 11/293802 | 11/293801 | 11/293808 | 11/293809 | 11/482975 |
| 11/482970 | 11/482968 | 11/482972 | 11/482971 | 11/482969 | 6431777 | 6334664 |
| 6447113 | 7239407 | 6398359 | 6652089 | 6652090 | 7057759 | 6631986 |
| 7187470 | 7280235 | 11/501775 | 11744210 | 11/859784 | 6471331 | 6676250 |
| 6347864 | 6439704 | 6425700 | 6588952 | 6626515 | 6722758 | 6871937 |
| 11/060803 | 11/097266 | 7328976 | 11/685084 | 11/685086 | 11/685090 | 11/740925 |
| 11/763444 | 11/763443 | 11946840 | 11961712 | 12/017771 | 7249942 | 7206654 |
| 7162324 | 7162325 | 7231275 | 7146236 | 7278847 | 10/753499 | 6997698 |
| 7220112 | 7231276 | 10/753440 | 7220115 | 7195475 | 7144242 | 7306323 |
| 7306319 | 11/525858 | 7322674 | 11/599335 | 11/706380 | 11736545 | 11/736554 |
| 11/739047 | 11749159 | 11/739073 | 11/775160 | 11/853755 | 11/940291 | 11934071 |
| 11951913 | 6786420 | 6827282 | 6948661 | 7073713 | 10/983060 | 7093762 |
| 7083108 | 7222799 | 7201319 | 11/442103 | 11/739071 | 11/518238 | 11/518280 |
| 11/518244 | 11/518243 | 11/518242 | 7032899 | 6854724 | 7331651 | 7334870 |
| 7334875 | 11/357296 | 11/357298 | 11/357297 | 12015479 | 12/017270 | 12015218 |
| 6350023 | 6318849 | 6592207 | 6439699 | 6312114 | 11/246676 | 11/246677 |
| 11/246678 | 11/246679 | 11/246680 | 11/246681 | 11/246714 | 11/246713 | 11/246689 |
| 11/246671 | 11/246670 | 11/246669 | 11/246704 | 11/246710 | 11/246688 | 11/246716 |
| 11/246715 | 11/246707 | 11/246706 | 11/246705 | 11/246708 | 11/246693 | 11/246692 |
| 11/246696 | 11/246695 | 11/246694 | 11/482958 | 11/482955 | 11/482962 | 11/482963 |
| 11/482956 | 11/482954 | 11/482974 | 11/482957 | 11/482987 | 11/482959 | 11/482960 |
| 11/482961 | 11/482964 | 11/482965 | 11/482976 | 11/482973 | 11/495815 | 11/495816 |
| 11/495817 | 60992635 | 60992637 | 60992641 | 10/803074 | 10/803073 | 7040823 |
| 10/803076 | 10/803077 | 10/803078 | 10/803079 | 10/922971 | 10/922970 | 10/922836 |
| 10/922842 | 10/922848 | 10/922843 | 7125185 | 7229226 | 11/513386 | 11/753559 |
| 10/815621 | 7243835 | 10/815630 | 10/815637 | 10/815638 | 7251050 | 10/815642 |
| 7097094 | 7137549 | 10/815618 | 7156292 | 11738974 | 10/815635 | 10/815647 |
| 10/815634 | 7137566 | 7131596 | 7128265 | 7207485 | 7197374 | 7175089 |
| 10/815617 | 10/815620 | 7178719 | 10/815613 | 7207483 | 7296737 | 7270266 |
| 10/815614 | 7314181 | 11/488162 | 11/488163 | 11/488164 | 11/488167 | 11/488168 |
| 11/488165 | 11/488166 | 7267273 | 11/834628 | 11/839497 | 11/944449 | 10/815636 |
| 7128270 | 11/041650 | 11/041651 | 11/041652 | 11/041649 | 11/041610 | 11863253 |
| 11863255 | 11/863257 | 11863258 | 11863262 | 11/041609 | 11/041626 | 11/041627 |
| 11/041624 | 11/041625 | 11863268 | 11863269 | 11863270 | 11863271 | 11863273 |
| 76584733 | 11/041556 | 11/041580 | 11/041723 | 11/041698 | 11/041648 | 11863263 |
| 11863264 | 11863265 | 11863266 | 11863267 | 10/815609 | 7150398 | 7159777 |
| 10/815610 | 7188769 | 7097106 | 7070110 | 7243849 | 7314177 | 11/480957 |
| 11/764694 | 11957470 | 6227652 | 6213588 | 6213589 | 6231163 | 6247795 |
| 6394581 | 6244691 | 6257704 | 6416168 | 6220694 | 6257705 | 6247794 |
| 6234610 | 6247793 | 6264306 | 6241342 | 6247792 | 6264307 | 6254220 |
| 6234611 | 6302528 | 6283582 | 6239821 | 6338547 | 6247796 | 6557977 |
| 6390603 | 6362843 | 6293653 | 6312107 | 6227653 | 6234609 | 6238040 |
| 6188415 | 6227654 | 6209989 | 6247791 | 6336710 | 6217153 | 6416167 |
| 6243113 | 6283581 | 6247790 | 6260953 | 6267469 | 6588882 | 6742873 |
| 6918655 | 6547371 | 6938989 | 6598964 | 6923526 | 6273544 | 6309048 |
| 6420196 | 6443558 | 6439689 | 6378989 | 6848181 | 6634735 | 6299289 |
| 6299290 | 6425654 | 6902255 | 6623101 | 6406129 | 6505916 | 6457809 |
| 6550895 | 6457812 | 7152962 | 6428133 | 7216956 | 7080895 | 11/144844 |
| 7182437 | 11/599341 | 11/635533 | 11/607976 | 11/607975 | 11/607999 | 11/607980 |
| 11/607979 | 11/607978 | 11/735961 | 11/685074 | 11/696126 | 11/696144 | 11/696650 |
| 11/763446 | 6224780 | 6235212 | 6280643 | 6284147 | 6214244 | 6071750 |
| 6267905 | 6251298 | 6258285 | 6225138 | 6241904 | 6299786 | 6866789 |
| 6231773 | 6190931 | 6248249 | 6290862 | 6241906 | 6565762 | 6241905 |
| 6451216 | 6231772 | 6274056 | 6290861 | 6248248 | 6306671 | 6331258 |
| 6110754 | 6294101 | 6416679 | 6264849 | 6254793 | 6245246 | 6855264 |
| 6235211 | 6491833 | 6264850 | 6258284 | 6312615 | 6228668 | 6180427 |
| 6171875 | 6267904 | 6245247 | 6315914 | 7169316 | 6526658 | 7210767 |
| 11/056146 | 11/635523 | 6665094 | 6450605 | 6512596 | 6654144 | 7125090 |
| 6687022 | 7072076 | 7092125 | 7215443 | 7136195 | 7077494 | 6877834 |
| 6969139 | 10/636227 | 7283280 | 6912067 | 7277205 | 7154637 | 10/636230 |
| 7070251 | 6851782 | 10/636211 | 10/636247 | 6843545 | 7079286 | 7064867 |
| 7065247 | 7027177 | 7218415 | 7064873 | 6954276 | 7061644 | 7092127 |
| 7059695 | 10/990382 | 7177052 | 7270394 | 11/124231 | 7188921 | 7187469 |
| 7196820 | 11/281445 | 7283281 | 7251051 | 7245399 | 11/524911 | 11/640267 |
| 11/706297 | 11/730387 | 11/737142 | 7336397 | 11/834637 | 11/853019 | 11/863239 |
| 12015485 | 12030797 | 11/305274 | 11/305273 | 11/305275 | 11/305152 | 11/305158 |
| 11/305008 | 6231148 | 6293658 | 6614560 | 6238033 | 6312070 | 6238111 |
| 6378970 | 6196739 | 6270182 | 6152619 | 7006143 | 6876394 | 6738096 |
| 6970186 | 6287028 | 6412993 | 11/033145 | 11/102845 | 11/102861 | 11/248421 |
| 11/672878 | 7204941 | 7282164 | 10/815628 | 11845672 | 7278727 | 10/913373 |
| 10/913374 | 10/913372 | 7138391 | 7153956 | 10/913380 | 10/913379 | 10/913376 |
| 7122076 | 7148345 | 11/172816 | 11/172815 | 11/172814 | 11/482990 | 11/482986 |
| 11/482985 | 11/454899 | 11/583942 | 11/592990 | 11849360 | 11/831961 | 11/831962 |
| 11/831963 | 60951700 | 11/832629 | 11/832637 | 60971535 | 61027756 | 10/407212 |
| 7252366 | 10/683064 | 10/683041 | 7275811 | 10/884889 | 10/922890 | 7334874 |
| 10/922885 | 10/922889 | 10/922884 | 10/922879 | 10/922887 | 10/922888 | 10/922874 |
| 7234795 | 10/922871 | 7328975 | 7293855 | 10/922882 | 10/922883 | 10/922878 |
| 10/922872 | 10/922876 | 10/922886 | 10/922877 | 7147792 | 7175774 | 11/159193 |
| 11/491378 | 11766713 | 11/841647 | 12018040 | 12035410 | 12037054 | 11/482980 |
| 11/563684 | 11/482967 | 11/482966 | 11/482988 | 11/482989 | 11/293832 | 11/293838 |
| 11/293825 | 11/293841 | 11/293799 | 11/293796 | 11/293797 | 11/293798 | 11/124158 |
| 11/124196 | 11/124199 | 11/124162 | 11/124202 | 11/124197 | 11/124154 | 11/124198 |
| 7284921 | 11/124151 | 11/124160 | 11/124192 | 11/124175 | 11/124163 | 11/124149 |
| 11/124152 | 11/124173 | 11/124155 | 7236271 | 11/124174 | 11/124194 | 11/124164 |
| 11/124200 | 11/124195 | 11/124166 | 11/124150 | 11/124172 | 11/124165 | 11/124186 |
| 11/124185 | 11/124184 | 11/124182 | 11/124201 | 11/124171 | 11/124181 | 11/124161 |
| 11/124156 | 11/124191 | 11/124159 | 11/124176 | 11/124188 | 11/124170 | 11/124187 |
| 11/124189 | 11/124190 | 11/124180 | 11/124193 | 11/124183 | 11/124178 | 11/124177 |
| 11/124148 | 11/124168 | 11/124167 | 11/124179 | 11/124169 | 11/187976 | 11/188011 |
| 11/188014 | 11/482979 | 11/735490 | 11/853018 | 11/944450 | 12023815 | 12035414 |
| 11/228540 | 11/228500 | 11/228501 | 11/228530 | 11/228490 | 11/228531 | 11/228504 |
| 11/228533 | 11/228502 | 11/228507 | 11/228482 | 11/228505 | 11/228497 | 11/228487 |
| 11/228529 | 11/228484 | 11/228489 | 11/228518 | 11/228536 | 11/228496 | 11/228488 |
| 11/228506 | 11/228516 | 11/228526 | 11/228539 | 11/228538 | 11/228524 | 11/228523 |
| 11/228519 | 11/228528 | 11/228527 | 11/228525 | 11/228520 | 11/228498 | 11/228511 |
| 11/228522 | 11/228515 | 11/228537 | 11/228534 | 11/228491 | 11/228499 | 11/228509 |
| 11/228492 | 11/228493 | 11/228510 | 11/228508 | 11/228512 | 11/228514 | 11/228494 |
| 11/228495 | 11/228486 | 11/228481 | 11/228477 | 11/228485 | 11/228483 | 11/228521 |
| 11/228517 | 11/228532 | 11/228513 | 11/228503 | 11/228480 | 11/228535 | 11/228478 |
| 11/228479 | 12035419 | 6238115 | 6386535 | 6398344 | 6612240 | 6752549 |
| 6805049 | 6971313 | 6899480 | 6860664 | 6925935 | 6966636 | 7024995 |
| 7284852 | 6926455 | 7056038 | 6869172 | 7021843 | 6988845 | 6964533 |
| 6981809 | 7284822 | 7258067 | 7322757 | 7222941 | 7284925 | 7278795 |
| 7249904 | 11/737726 | 11772240 | 11/863246 | 11/863145 | 11/865650 | 6087638 |
| 6340222 | 6041600 | 6299300 | 6067797 | 6286935 | 6044646 | 6382769 |
| 6787051 | 6938990 | 11/242916 | 11/144799 | 11/198235 | 11861282 | 11861284 |
| 11/766052 | 7152972 | 11/592996 | D529952 | 6390605 | 6322195 | 6612110 |
| 6480089 | 6460778 | 6305788 | 6426014 | 6364453 | 6457795 | 6315399 |
| 6338548 | 7040736 | 6938992 | 6994425 | 6863379 | 6540319 | 6994421 |
| 6984019 | 7008043 | 6997544 | 6328431 | 6991310 | 10/965772 | 7140723 |
| 6328425 | 6982184 | 7267423 | 7134741 | 7066577 | 7152945 | 7303689 |
| 7021744 | 6991320 | 7155911 | 11/107799 | 6595624 | 7152943 | 7125103 |
| 7328971 | 7290857 | 7285437 | 7229151 | 11/330058 | 7237873 | 11/329163 |
| 11/442180 | 11/450431 | 7213907 | 6417757 | 11/482951 | 11/545566 | 11/583826 |
| 11/604315 | 11/604323 | 11/643845 | 11/706950 | 11/730399 | 11749121 | 11/753549 |
| 11/834630 | 11/935389 | 11/869670 | 7095309 | 11/945157 | 11957473 | 11967235 |
| 12017896 | 6854825 | 6623106 | 6672707 | 6575561 | 6817700 | 6588885 |
| 7075677 | 6428139 | 6575549 | 6846692 | 6425971 | 7063993 | 6383833 |
| 6955414 | 6412908 | 6746105 | 6953236 | 6412904 | 7128388 | 6398343 |
| 6652071 | 6793323 | 6659590 | 6676245 | 7201460 | 6464332 | 6659593 |
| 6478406 | 6978613 | 6439693 | 6502306 | 6966111 | 6863369 | 6428142 |
| 6874868 | 6390591 | 6799828 | 6896358 | 7018016 | 10/296534 | 6328417 |
| 6322194 | 6382779 | 6629745 | 6565193 | 6609786 | 6609787 | 6439908 |
| 6684503 | 6843551 | 6764166 | 6561617 | 10/510092 | 6557970 | 6546628 |
| 10/510098 | 6652074 | 6820968 | 7175260 | 6682174 | 7303262 | 6648453 |
| 6834932 | 6682176 | 6998062 | 6767077 | 7278717 | 6755509 | 10/534813 |
| 6692108 | 10/534811 | 6672709 | 7303263 | 7086718 | 10/534881 | 6672710 |
| 10/534812 | 6669334 | 7322686 | 7152958 | 7281782 | 6824246 | 7264336 |
| 6669333 | 10/534815 | 6820967 | 7306326 | 6736489 | 7264335 | 6719406 |
| 7222943 | 7188419 | 7168166 | 6974209 | 7086719 | 6974210 | 7195338 |
| 7252775 | 7101025 | 11/474281 | 11/485258 | 11/706304 | 11/706324 | 11/706326 |
| 11/706321 | 11/772239 | 11/782598 | 11/829941 | 11/852991 | 11852986 | 11/936062 |
| 11/934027 | 11955028 | 12034578 | 12036908 | 11/763440 | 11/763442 | 11/246687 |
| 11/246718 | 7322681 | 11/246686 | 11/246703 | 11/246691 | 11/246711 | 11/246690 |
| 11/246712 | 11/246717 | 11/246709 | 11/246700 | 11/246701 | 11/246702 | 11/246668 |
| 11/246697 | 11/246698 | 11/246699 | 11/246675 | 11/246674 | 11/246667 | 11/829957 |
| 11/829960 | 11/829961 | 11/829962 | 11/829963 | 11/829966 | 11/829967 | 11/829968 |
| 11/829969 | 11946839 | 11946838 | 11946837 | 11951230 | 7156508 | 7159972 |
| 7083271 | 7165834 | 7080894 | 7201469 | 7090336 | 7156489 | 10/760233 |
| 10/760246 | 7083257 | 7258422 | 7255423 | 7219980 | 10/760253 | 10/760255 |
| 10/760209 | 7118192 | 10/760194 | 7322672 | 7077505 | 7198354 | 7077504 |
| 10/760189 | 7198355 | 10/760232 | 7322676 | 7152959 | 7213906 | 7178901 |
| 7222938 | 7108353 | 7104629 | 11/446227 | 11/454904 | 11/472345 | 11/474273 |
| 7261401 | 11/474279 | 11/482939 | 7328972 | 7322673 | 7306324 | 7306325 |
| 11/603824 | 11/601756 | 11/601672 | 7303261 | 11/653253 | 11/706328 | 11/706299 |
| 11/706965 | 11/737080 | 11/737041 | 11/778062 | 11/778566 | 11/782593 | 11/934018 |
| 11/945157 | 11951095 | 11951828 | 11954906 | 11954949 | 11967226 | 7303930 |
| 11/246672 | 11/246673 | 11/246683 | 11/246682 | 60/939086 | 11860538 | 11860539 |
| 11/860540 | 11860541 | 11860542 | 11/936060 | 11877667 | 11877668 | 7246886 |
| 7128400 | 7108355 | 6991322 | 7287836 | 7118197 | 10/728784 | 10/728783 |
| 7077493 | 6962402 | 10/728803 | 7147308 | 10/728779 | 7118198 | 7168790 |
| 7172270 | 7229155 | 6830318 | 7195342 | 7175261 | 10/773183 | 7108356 |
| 7118202 | 10/773186 | 7134744 | 10/773185 | 7134743 | 7182439 | 7210768 |
| 10/773187 | 7134745 | 7156484 | 7118201 | 7111926 | 10/773184 | 7018021 |
| 11/060751 | 11/060805 | 11/188017 | 7128402 | 11/298774 | 11/329157 | 11/490041 |
| 11/501767 | 7284839 | 7246885 | 7229156 | 11/505846 | 11/505857 | 7293858 |
| 11/524908 | 11/524938 | 7258427 | 11/524912 | 7278716 | 11/592995 | 11/603825 |
| 11/649773 | 11/650549 | 11/653237 | 11/706378 | 11/706962 | 11749118 | 11/754937 |
| 11749120 | 11/744885 | 11/779850 | 11/765439 | 11/842950 | 11/839539 | 11/926121 |
| 12025621 | 11/097308 | 11/097309 | 7246876 | 11/097299 | 11/097310 | 11/097213 |
| 7328978 | 7334876 | 7147306 | 7261394 | 11/764806 | 11/782595 | 11965696 |
| 12/027286 | 11/482953 | 11/482977 | 11/544778 | 11/544779 | 11/764808 | 11/756624 |
| 11/756625 | 11/756626 | 11/756627 | 11/756628 | 11/756629 | 11/756630 | 11/756631 |
| 7156289 | 7178718 | 7225979 | 11/712434 | 11/084796 | 11/084742 | 11/084806 |
| 09/575197 | 09/575197 | 7079712 | 7079712 | 6825945 | 6825945 | 7330974 |
| 7330974 | 6813039 | 6813039 | 7190474 | 6987506 | 6987506 | 6824044 |
| 7038797 | 7038797 | 6980318 | 6980318 | 6816274 | 6816274 | 7102772 |
| 7102772 | 09/575186 | 09/575186 | 6681045 | 6681045 | 6678499 | 6679420 |
| 6963845 | 6976220 | 6728000 | 6728000 | 7110126 | 7173722 | 7173722 |
| 6976035 | 6813558 | 6766942 | 6965454 | 6995859 | 7088459 | 7088459 |
| 6720985 | 7286113 | 6922779 | 6978019 | 6847883 | 7131058 | 7295839 |
| 09/607843 | 09/693690 | 6959298 | 6973450 | 7150404 | 6965882 | 7233924 |
| 09/575181 | 09/575181 | 09/722174 | 7175079 | 7162259 | 6718061 | 10/291523 |
| 10/291471 | 7012710 | 6825956 | 10/291481 | 7222098 | 10/291825 | 7263508 |
| 7031010 | 6972864 | 6862105 | 7009738 | 6989911 | 6982807 | 10/291576 |
| 6829387 | 6714678 | 6644545 | 6609653 | 6651879 | 10/291555 | 7293240 |
| 10/291592 | 10/291542 | 7044363 | 7004390 | 6867880 | 7034953 | 6987581 |
| 7216224 | 10/291821 | 7162269 | 7162222 | 7290210 | 7293233 | 7293234 |
| 6850931 | 6865570 | 6847961 | 10/685523 | 10/685583 | 7162442 | 10/685584 |
| 7159784 | 10/804034 | 10/793933 | 6889896 | 10/831232 | 7174056 | 6996274 |
| 7162088 | 10/943874 | 10/943872 | 10/944044 | 7259884 | 10/944043 | 7167270 |
| 10/943877 | 6986459 | 10/954170 | 7181448 | 10/981626 | 10/981616 | 7324989 |
| 7231293 | 7174329 | 10/992713 | 7295922 | 7200591 | 11/020106 | 11/020260 |
| 11/020321 | 11/020319 | 11/026045 | 11/059696 | 11/051032 | 11/059674 | 11/107944 |
| 11/107941 | 11/082940 | 11/082815 | 11/082827 | 11/082829 | 6991153 | 6991154 |
| 11/124256 | 11/123136 | 11/154676 | 7322524 | 11/182002 | 11/202251 | 11/202252 |
| 11/202253 | 11/203200 | 11/202218 | 11/206778 | 11/203424 | 11/222977 | 7327485 |
| 11/227239 | 11/286334 | 7225402 | 11/329187 | 11/349143 | 11/491225 | 11/491121 |
| 11/442428 | 11/454902 | 11/442385 | 11/478590 | 7271931 | 11/520170 | 11/603057 |
| 11/706964 | 11/739032 | 11739014 | 7336389 | 11/830848 | 11/830849 | 11/839542 |
| 11/866394 | 11/934077 | 11951874 | 12015487 | 12023860 | 12023005 | 12036266 |
| 7068382 | 7068382 | 7007851 | 6957921 | 6457883 | 10/743671 | 7044381 |
| 11/203205 | 7094910 | 7091344 | 7122685 | 7038066 | 7099019 | 7062651 |
| 7062651 | 6789194 | 6789194 | 6789191 | 6789191 | 10/900129 | 7278018 |
| 10/913350 | 10/982975 | 10/983029 | 11/331109 | 6644642 | 6644642 | 6502614 |
| 6502614 | 6622999 | 6622999 | 6669385 | 6669385 | 6827116 | 7011128 |
| 10/949307 | 6549935 | 6549935 | 6987573 | 6987573 | 6727996 | 6727996 |
| 6591884 | 6591884 | 6439706 | 6439706 | 6760119 | 6760119 | 7295332 |
| 7295332 | 7064851 | 6826547 | 6290349 | 6290349 | 6428155 | 6428155 |
| 6785016 | 6785016 | 6831682 | 6741871 | 6927871 | 6980306 | 6965439 |
| 6840606 | 7036918 | 6977746 | 6970264 | 7068389 | 7093991 | 7190491 |
| 10/901154 | 10/932044 | 10/962412 | 7177054 | 10/962552 | 10/965733 | 10/965933 |
| 10/974742 | 10/982974 | 7180609 | 10/986375 | 11/107817 | 7292363 | 11/149160 |
| 11/206756 | 11/250465 | 7202959 | 11/653219 | 11/706309 | 11/730389 | 11/730392 |
| 60/953443 | 11/866387 | 60974077 | 6982798 | 6870966 | 6870966 | 6822639 |
| 6822639 | 6474888 | 6627870 | 6724374 | 6788982 | 7263270 | 6788293 |
| 6946672 | 6737591 | 6737591 | 7091960 | 09/693514 | 6792165 | 7105753 |
| 6795593 | 6980704 | 6768821 | 7132612 | 7041916 | 6797895 | 7015901 |
| 7289882 | 7148644 | 10/778056 | 10/778058 | 10/778060 | 10/778059 | 10/778063 |
| 10/778062 | 10/778061 | 10/778057 | 7096199 | 7286887 | 10/917467 | 10/917466 |
| 7324859 | 7218978 | 7245294 | 7277085 | 7187370 | 10/917436 | 10/943856 |
| 10/919379 | 7019319 | 10/943878 | 10/943849 | 7043096 | 7148499 | 11/144840 |
| 11/155556 | 11/155557 | 11/193481 | 11/193435 | 11/193482 | 11/193479 | 7336267 |
| 11/281671 | 11/298474 | 7245760 | 11/488832 | 11/495814 | 11/495823 | 11/495822 |
| 11/495821 | 11/495820 | 11/653242 | 11/754370 | 60911260 | 11/829936 | 11/839494 |
| 11866305 | 11866313 | 11866324 | 11866336 | 11866348 | 11866359 | 11970951 |
| 12036264 | 7055739 | 7055739 | 7233320 | 7233320 | 6830196 | 6830196 |
| 6832717 | 6832717 | 7182247 | 7120853 | 7082562 | 6843420 | 10/291718 |
| 6789731 | 7057608 | 6766944 | 6766945 | 7289103 | 10/291559 | 7299969 |
| 7264173 | 10/409864 | 7108192 | 10/537159 | 7111791 | 7077333 | 6983878 |
| 10/786631 | 7134598 | 10/893372 | 6929186 | 6994264 | 7017826 | 7014123 |
| 7134601 | 7150396 | 10/971146 | 7017823 | 7025276 | 7284701 | 7080780 |
| 11/074802 | 7334739 | 11749158 | 11/842948 | 12015477 | 12025746 | 12025747 |
| 12025748 | 12025749 | 12025750 | 12025751 | 12025754 | 12025756 | 12025757 |
| 12025759 | 12025760 | 12025761 | 12025762 | 12025764 | 12025765 | 12025766 |
| 12025767 | 12025768 | 10/492169 | 10/492152 | 10/492168 | 10/492161 | 7308148 |
| 10/502575 | 10/531229 | 10/683151 | 10/531733 | 10/683040 | 10/510391 | 10/919260 |
| 10/510392 | 10/778090 | 11/944404 | 11/936638 | 12031615 | 6957768 | 6957768 |
| 09/575172 | 09/575172 | 7170499 | 7170499 | 7106888 | 7106888 | 7123239 |
| 7123239 | 6982701 | 6982703 | 7227527 | 6786397 | 6947027 | 6975299 |
| 7139431 | 7048178 | 7118025 | 6839053 | 7015900 | 7010147 | 7133557 |
| 6914593 | 10/291546 | 6938826 | 7278566 | 7123245 | 6992662 | 7190346 |
| 11/074800 | 11/074782 | 11/074777 | 11/075917 | 7221781 | 11/102843 | 7213756 |
| 11/188016 | 7180507 | 7263225 | 7287688 | 11/737094 | 11/753570 | 11/782596 |
| 11/865711 | 12036904 | 11856061 | 11856062 | 11856064 | 11856066 | 11/672522 |
| 11/672950 | 11/672947 | 11/672891 | 11/672954 | 11/672533 | 11754310 | 11/754321 |
| 11/754320 | 11/754319 | 11/754318 | 11/754317 | 11/754316 | 11/754315 | 11/754314 |
| 11/754313 | 11/754312 | 11/754311 | 12015507 | 12015508 | 12015509 | 12015510 |
| 12015511 | 12015512 | 12015513 | 6593166 | 7132679 | 6940088 | 7119357 |
| 7307272 | 6755513 | 6974204 | 6409323 | 7055930 | 6281912 | 6893109 |
| 6604810 | 6824242 | 6318920 | 7210867 | 6488422 | 6655786 | 6457810 |
| 6485135 | 6796731 | 6904678 | 6641253 | 7125106 | 6786658 | 7097273 |
| 6824245 | 7222947 | 6918649 | 6860581 | 6929351 | 7063404 | 6969150 |
| 7004652 | 6871938 | 6905194 | 6846059 | 6997626 | 7303256 | 7029098 |
| 6966625 | 7114794 | 7207646 | 7077496 | 7284831 | 11/072529 | 7152938 |
| 7182434 | 7182430 | 7306317 | 7032993 | 7325905 | 11/155545 | 11/144813 |
| 7172266 | 7258430 | 7128392 | 7210866 | 7306322 | 11/505933 | 11/540727 |
| 11/635480 | 11/707946 | 11/706303 | 11/709084 | 11/730776 | 11/744143 | 11/779845 |
| 11/782589 | 11/863256 | 11/940302 | 11/940235 | 11955359 | 12019583 | 12019566 |
| 12036910 | 11/066161 | 11/066160 | 11/066159 | 11/066158 | 7287831 | 11/875936 |
| 12017818 | 6804030 | 6807315 | 6771811 | 6683996 | 7271936 | 7304771 |
| 6965691 | 7058219 | 7289681 | 7187807 | 7181063 | 11/338783 | 11/603823 |
| 11/650536 | 12025633 | 10/727181 | 10/727162 | 10/727163 | 10/727245 | 7121639 |
| 7165824 | 7152942 | 10/727157 | 7181572 | 7096137 | 7302592 | 7278034 |
| 7188282 | 10/727159 | 10/727180 | 10/727179 | 10/727192 | 10/727274 | 10/727164 |
| 10/727161 | 10/727198 | 10/727158 | 10/754536 | 10/754938 | 10/727227 | 10/727160 |
| 10/934720 | 7171323 | 7278697 | 11/442131 | 11/474278 | 11/488853 | 7328115 |
| 11749750 | 11749749 | 11955127 | 11951213 | 10/296522 | 6795215 | 7070098 |
| 7154638 | 6805419 | 6859289 | 6977751 | 6398332 | 6394573 | 6622923 |
| 6747760 | 6921144 | 10/884881 | 7092112 | 7192106 | 11/039866 | 7173739 |
| 6986560 | 7008033 | 11/148237 | 7222780 | 7270391 | 7150510 | 11/478599 |
| 11/499749 | 11/521388 | 11/738518 | 11/482981 | 11/743662 | 11/743661 | 11/743659 |
| 11/743655 | 11/743657 | 11/752900 | 11926109 | 11/927163 | 11929567 | 7195328 |
| 7182422 | 11/650537 | 11/712540 | 10/854521 | 10/854522 | 10/854488 | 7281330 |
| 10/854503 | 10/854504 | 10/854509 | 7188928 | 7093989 | 10/854497 | 10/854495 |
| 10/854498 | 10/854511 | 10/854512 | 10/854525 | 10/854526 | 10/854516 | 7252353 |
| 10/854515 | 7267417 | 10/854505 | 10/854493 | 7275805 | 7314261 | 10/854490 |
| 7281777 | 7290852 | 10/854528 | 10/854523 | 10/854527 | 10/854524 | 10/854520 |
| 10/854514 | 10/854519 | 10/854513 | 10/854499 | 10/854501 | 7266661 | 7243193 |
| 10/854518 | 10/854517 | 10/934628 | 7163345 | 7322666 | 11/601757 | 11/706295 |
| 11/735881 | 11748483 | 11749123 | 11/766061 | 11775135 | 11772235 | 11/778569 |
| 11/829942 | 11/870342 | 11/935274 | 11/937239 | 11961907 | 11961940 | 11961961 |
| 11/014731 | D529081 | D541848 | D528597 | 6924907 | 6712452 | 6416160 |
| 6238043 | 6958826 | 6812972 | 6553459 | 6967741 | 6956669 | 6903766 |
| 6804026 | 7259889 | 6975429 | 10/636234 | 10/636233 | 7301567 | 10/636216 |
| 7274485 | 7139084 | 7173735 | 7068394 | 7286182 | 7086644 | 7250977 |
| 7146281 | 7023567 | 7136183 | 7083254 | 6796651 | 7061643 | 7057758 |
| 6894810 | 6995871 | 7085010 | 7092126 | 7123382 | 7061650 | 10/853143 |
| 6986573 | 6974212 | 7307756 | 7173737 | 10/954168 | 7246868 | 11/065357 |
| 7137699 | 11/107798 | 7148994 | 7077497 | 11/176372 | 7248376 | 11/225158 |
| 7306321 | 7173729 | 11/442132 | 11/478607 | 11/503085 | 11/545502 | 11/583943 |
| 11/585946 | 11/653239 | 11/653238 | 11/764781 | 11/764782 | 11/779884 | 11845666 |
| 11/872637 | 11/944401 | 11/940215 | 11/544764 | 11/544765 | 11/544772 | 11/544773 |
| 11/544774 | 11/544775 | 11/544776 | 11/544766 | 11/544767 | 11/544771 | 11/544770 |
| 11/544769 | 11/544777 | 11/544768 | 11/544763 | 11/293804 | 11/293840 | 11/293803 |
| 11/293833 | 11/293834 | 11/293835 | 11/293836 | 11/293837 | 11/293792 | 11/293794 |
| 11/293839 | 11/293826 | 11/293829 | 11/293830 | 11/293827 | 11/293828 | 7270494 |
| 11/293823 | 11/293824 | 11/293831 | 11/293815 | 11/293819 | 11/293818 | 11/293817 |
| 11/293816 | 11/838875 | 11/482978 | 11/640356 | 11/640357 | 11/640358 | 11/640359 |
| 11/640360 | 11/640355 | 11/679786 | 11/872714 | 10/760254 | 10/760210 | 10/760202 |
| 7201468 | 10/760198 | 10/760249 | 7234802 | 7303255 | 7287846 | 7156511 |
| 10/760264 | 7258432 | 7097291 | 10/760222 | 10/760248 | 7083273 | 10/760192 |
| 10/760203 | 10/760204 | 10/760205 | 10/760206 | 10/760267 | 10/760270 | 7198352 |
| 10/760271 | 7303251 | 7201470 | 7121655 | 7293861 | 7232208 | 7328985 |
| 10/760261 | 7083272 | 7261400 | 11/474272 | 11/474315 | 7311387 | 11/583874 |
| 7303258 | 11/706322 | 11/706968 | 11/749119 | 11749157 | 11779848 | 11/782590 |
| 11/855152 | 11855151 | 11/870327 | 11/934780 | 11/935992 | 11951193 | 12/017327 |
| 12015273 | 12036882 | 11/014764 | 11/014763 | 7331663 | 11/014747 | 7328973 |
| 11/014760 | 11/014757 | 7303252 | 7249822 | 11/014762 | 7311382 | 11/014723 |
| 11/014756 | 11/014736 | 11/014759 | 11/014758 | 11/014725 | 7331660 | 11/014738 |
| 11/014737 | 7322684 | 7322685 | 7311381 | 7270405 | 7303268 | 11/014735 |
| 11/014734 | 11/014719 | 11/014750 | 11/014749 | 7249833 | 11/758640 | 11/775143 |
| 11/838877 | 11944453 | 11/944633 | 11955065 | 12/003952 | 12007818 | 12007817 |
| 12071187 | 11/014769 | 11/014729 | 7331661 | 11/014733 | 7300140 | 11/014755 |
| 11/014765 | 11/014766 | 11/014740 | 7284816 | 7284845 | 7255430 | 11/014744 |
| 7328984 | 11/014768 | 7322671 | 11/014718 | 11/014717 | 11/014716 | 11/014732 |
| 11/014742 | 11/097268 | 11/097185 | 11/097184 | 11/778567 | 11852958 | 11852907 |
| 11/872038 | 11955093 | 11961578 | 12022023 | 12023000 | 12023018 | 12031582 |
| 12043708 | 11/293820 | 11/293813 | 11/293822 | 11/293812 | 11/293821 | 11/293814 |
| 11/293793 | 11/293842 | 11/293811 | 11/293807 | 11/293806 | 11/293805 | 11/293810 |
| 11/688863 | 11/688864 | 11/688865 | 11/688866 | 11/688867 | 11/688868 | 11/688869 |
| 11/688871 | 11/688872 | 11/688873 | 11/741766 | 12014767 | 12014768 | 12014769 |
| 12014770 | 12014771 | 12014772 | 12014773 | 12014774 | 12014775 | 12014776 |
| 12014777 | 12014778 | 12014779 | 12014780 | 12014781 | 12014782 | 12014783 |
| 12014784 | 12014785 | 12014787 | 12014788 | 12014789 | 12014790 | 12014791 |
| 12014792 | 12014793 | 12014794 | 12014796 | 12014798 | 12014801 | 12014803 |
| 12014804 | 12014805 | 12014806 | 12014807 | 61034147 | 11/482982 | 11/482983 |
| 11/482984 | 11/495818 | 11/495819 | 11/677049 | 11/677050 | 11/677051 | 11872719 |
| 11872718 | 61033357 | 7306320 | 11/934781 | D528156 | 10/760180 | 7111935 |
| 10/760213 | 10/760219 | 10/760237 | 7261482 | 10/760220 | 7002664 | 10/760252 |
| 10/760265 | 7088420 | 11/446233 | 11/503083 | 11/503081 | 11/516487 | 11/599312 |
| 6364451 | 6533390 | 6454378 | 7224478 | 6559969 | 6896362 | 7057760 |
| 6982799 | 11/202107 | 11/743672 | 11744126 | 11/743673 | 7093494 | 7143652 |
| 7089797 | 7159467 | 7234357 | 7124643 | 7121145 | 7089790 | 7194901 |
| 6968744 | 7089798 | 7240560 | 7137302 | 11/442177 | 7171855 | 7260995 |
| 7260993 | 7165460 | 7222538 | 7258019 | 11/543047 | 7258020 | 11/604324 |
| 7334480 | 11/706305 | 11/707056 | 11744211 | 11/767526 | 11/779846 | 11/764227 |
| 11/829943 | 11/829944 | 12015390 | 12031475 | 6454482 | 6808330 | 6527365 |
| 6474773 | 6550997 | 7093923 | 6957923 | 7131724 | 10/949288 | 7168867 |
| 7125098 | 11/706966 | 11/185722 | 7249901 | 7188930 | 11/014728 | 11/014727 |
| D536031 | D531214 | 7237888 | 7168654 | 7201272 | 6991098 | 7217051 |
| 6944970 | 10/760215 | 7108434 | 10/760257 | 7210407 | 7186042 | 10/760266 |
| 6920704 | 7217049 | 10/760214 | 10/760260 | 7147102 | 7287828 | 7249838 |
| 10/760241 | 10/962413 | 10/962427 | 7261477 | 7225739 | 10/962402 | 10/962425 |
| 10/962428 | 7191978 | 10/962426 | 10/962409 | 10/962417 | 10/962403 | 7163287 |
| 7258415 | 7322677 | 7258424 | 10/962410 | 7195412 | 7207670 | 7270401 |
| 7220072 | 11/474267 | 11/544547 | 11/585925 | 11/593000 | 11/706298 | 11/706296 |
| 11/706327 | 11/730760 | 11/730407 | 11/730787 | 11/735977 | 11/736527 | 11/753566 |
| 11/754359 | 11/778061 | 11/765398 | 11/778556 | 11/829937 | 11/780470 | 11/866399 |
| 11/223262 | 11/223018 | 11/223114 | 11955366 | 7322761 | 11/223021 | 11/223020 |
| 11/223019 | 11/014730 | D541849 | 29/279123 | 6716666 | 6949217 | 6750083 |
| 7014451 | 6777259 | 6923524 | 6557978 | 6991207 | 6766998 | 6967354 |
| 6759723 | 6870259 | 10/853270 | 6925875 | 10/898214 | 7095109 | 7145696 |
| 10/976081 | 7193482 | 7134739 | 7222939 | 7164501 | 7118186 | 7201523 |
| 7226159 | 7249839 | 7108343 | 7154626 | 7079292 | 10/980184 | 7233421 |
| 7063408 | 10/983082 | 10/982804 | 7032996 | 10/982834 | 10/982833 | 10/982817 |
| 7217046 | 6948870 | 7195336 | 7070257 | 10/986813 | 10/986785 | 7093922 |
| 6988789 | 10/986788 | 7246871 | 10/992748 | 10/992747 | 7187468 | 10/992828 |
| 7196814 | 10/992754 | 7268911 | 7265869 | 7128384 | 7164505 | 7284805 |
| 7025434 | 7298519 | 7280244 | 7206098 | 7265877 | 7193743 | 7168777 |
| 11/006734 | 7195329 | 7198346 | 7281786 | 11/013363 | 11/013881 | 6959983 |
| 7128386 | 7097104 | 11/013636 | 7083261 | 7070258 | 7083275 | 7110139 |
| 6994419 | 6935725 | 11/026046 | 7178892 | 7219429 | 6988784 | 11/026135 |
| 7289156 | 11/064005 | 7284976 | 7178903 | 7273274 | 7083256 | 7325986 |
| 7278707 | 7325918 | 6974206 | 11/064004 | 7066588 | 7222940 | 11/075918 |
| 7018025 | 7221867 | 7290863 | 7188938 | 7021742 | 7083262 | 7192119 |
| 11/083021 | 7036912 | 7175256 | 7182441 | 7083258 | 7114796 | 7147302 |
| 11/084757 | 7219982 | 7118195 | 7229153 | 6991318 | 7108346 | 11/248429 |
| 11/239031 | 7178899 | 7066579 | 11/281419 | 20060087544 | 11/329188 | 11/329140 |
| 7270397 | 7258425 | 7237874 | 7152961 | 7333235 | 7207658 | 11/484744 |
| 7311257 | 7207659 | 11/525857 | 11/540569 | 11/583869 | 11/592985 | 11/585947 |
| 7306307 | 11/604316 | 11/604309 | 11/604303 | 11/643844 | 7329061 | 11/655940 |
| 11/653320 | 7278713 | 11/706381 | 11/706323 | 11/706963 | 11/713660 | 7290853 |
| 11/696186 | 11/730390 | 11/737139 | 11/737749 | 11/740273 | 11749122 | 11/754361 |
| 11766043 | 11/764775 | 11/768872 | 11/775156 | 11/779271 | 11/779272 | 11/829938 |
| 11/839502 | 11858852 | 11/862188 | 11859790 | 11/872618 | 11/923651 | 11950255 |
| 11930001 | 11955362 | 12015368 | 11965718 | 6485123 | 6425657 | 6488358 |
| 7021746 | 6712986 | 6981757 | 6505912 | 6439694 | 6364461 | 6378990 |
| 6425658 | 6488361 | 6814429 | 6471336 | 6457813 | 6540331 | 6454396 |
| 6464325 | 6443559 | 6435664 | 6412914 | 6488360 | 6550896 | 6439695 |
| 6447100 | 09/900160 | 6488359 | 6637873 | 10/485738 | 6618117 | 10/485737 |
| 6803989 | 7234801 | 7044589 | 7163273 | 6416154 | 6547364 | 10/485744 |
| 6644771 | 7152939 | 6565181 | 7325897 | 6857719 | 7255414 | 6702417 |
| 7284843 | 6918654 | 7070265 | 6616271 | 6652078 | 6503408 | 6607263 |
| 7111924 | 6623108 | 6698867 | 6488362 | 6625874 | 6921153 | 7198356 |
| 6536874 | 6425651 | 6435667 | 10/509997 | 6527374 | 7334873 | 6582059 |
| 10/510152 | 6513908 | 7246883 | 6540332 | 6547368 | 7070256 | 6508546 |
| 10/510151 | 6679584 | 7303254 | 6857724 | 10/509998 | 6652052 | 10/509999 |
| 6672706 | 10/510096 | 6688719 | 6712924 | 6588886 | 7077508 | 7207654 |
| 6935724 | 6927786 | 6988787 | 6899415 | 6672708 | 6644767 | 6874866 |
| 6830316 | 6994420 | 6954254 | 7086720 | 7240992 | 7267424 | 7128397 |
| 7084951 | 7156496 | 7066578 | 7101023 | 11/165027 | 11/202235 | 11/225157 |
| 7159965 | 7255424 | 11/349519 | 7137686 | 7201472 | 7287829 | 11/504602 |
| 7216957 | 11/520572 | 11/583858 | 11/583895 | 11/585976 | 11/635488 | 7278712 |
| 11/706952 | 11/706307 | 7287827 | 11944451 | 11/740287 | 11/754367 | 11/758643 |
| 11/778572 | 11859791 | 11/863260 | 11/874178 | 11/936064 | 11951983 | 12015483 |
| 6916082 | 6786570 | 10/753478 | 6848780 | 6966633 | 7179395 | 6969153 |
| 6979075 | 7132056 | 6832828 | 6860590 | 6905620 | 6786574 | 6824252 |
| 7097282 | 6997545 | 6971734 | 6918652 | 6978990 | 6863105 | 10/780624 |
| 7194629 | 10/791792 | 6890059 | 6988785 | 6830315 | 7246881 | 7125102 |
| 7028474 | 7066575 | 6986202 | 7044584 | 7210762 | 7032992 | 7140720 |
| 7207656 | 7285170 | 11/048748 | 7008041 | 7011390 | 7048868 | 7014785 |
| 7131717 | 7284826 | 7331101 | 7182436 | 7104631 | 7240993 | 7290859 |
| 11/202217 | 7172265 | 7284837 | 7066573 | 11/298635 | 7152949 | 7334877 |
| 11/442133 | 7326357 | 7156492 | 11/478588 | 7331653 | 7287834 | 11/525861 |
| 11/583939 | 11/545504 | 7284326 | 11/635485 | 11/730391 | 11/730788 | 11/749148 |
| 11/749149 | 11/749152 | 11/749151 | 11/759886 | 11/865668 | 11/874168 | 11/874203 |
| 11971182 | 12021086 | 12015441 | 11965722 | 6824257 | 7270475 | 6971811 |
| 6878564 | 6921145 | 6890052 | 7021747 | 6929345 | 6811242 | 6916087 |
| 6905195 | 6899416 | 6883906 | 6955428 | 7284834 | 6932459 | 6962410 |
| 7033008 | 6962409 | 7013641 | 7204580 | 7032997 | 6998278 | 7004563 |
| 6910755 | 6969142 | 6938994 | 7188935 | 10/959049 | 7134740 | 6997537 |
| 7004567 | 6916091 | 7077588 | 6918707 | 6923583 | 6953295 | 6921221 |
| 7001008 | 7168167 | 7210759 | 7337532 | 7331659 | 7322680 | 6988790 |
| 7192120 | 7168789 | 7004577 | 7052120 | 11/123007 | 6994426 | 7258418 |
| 7014298 | 7328977 | 11/177394 | 7152955 | 7097292 | 7207657 | 7152944 |
| 7147303 | 7338147 | 7134608 | 7264333 | 7093921 | 7077590 | 7147297 |
| 20060038853 | 11/248832 | 11/248428 | 11/248434 | 7077507 | 7172672 | 7175776 |
| 7086717 | 7101020 | 11/329155 | 7201466 | 11/330057 | 7152967 | 7182431 |
| 7210666 | 7252367 | 7287837 | 11/485255 | 11/525860 | 6945630 | 7018294 |
| 6910014 | 6659447 | 6648321 | 7082980 | 6672584 | 7073551 | 6830395 |
| 7289727 | 7001011 | 6880922 | 6886915 | 6644787 | 6641255 | 7066580 |
| 6652082 | 7284833 | 6666544 | 6666543 | 6669332 | 6984023 | 6733104 |
| 6644793 | 6723575 | 6953235 | 6663225 | 7076872 | 7059706 | 7185971 |
| 7090335 | 6854827 | 6793974 | 10/636258 | 7222929 | 6739701 | 7073881 |
| 7155823 | 7219427 | 7008503 | 6783216 | 6883890 | 6857726 | 10/636274 |
| 6641256 | 6808253 | 6827428 | 6802587 | 6997534 | 6959982 | 6959981 |
| 6886917 | 6969473 | 6827425 | 7007859 | 6802594 | 6792754 | 6860107 |
| 6786043 | 6863378 | 7052114 | 7001007 | 10/729151 | 10/729157 | 6948794 |
| 6805435 | 6733116 | 10/683006 | 7008046 | 6880918 | 7066574 | 6983595 |
| 6923527 | 7275800 | 7163276 | 7156495 | 6976751 | 6994430 | 7014296 |
| 7059704 | 7160743 | 7175775 | 7287839 | 7097283 | 7140722 | 11/123009 |
| 11/123008 | 7080893 | 7093920 | 7270492 | 7128093 | 7052113 | 7055934 |
| 11/155627 | 7278796 | 11/159197 | 7083263 | 7145592 | 7025436 | 11/281444 |
| 7258421 | 11/478591 | 7332051 | 7226147 | 11/482940 | 7195339 | 11/503061 |
| 11/505938 | 7284838 | 7293856 | 11/544577 | 11/540576 | 7325901 | 11/592991 |
| 11/599342 | 11/600803 | 11/604321 | 11/604302 | 11/635535 | 11/635486 | 11/643842 |
| 11/655987 | 11/650541 | 11/706301 | 11/707039 | 11/730388 | 11/730786 | 11/730785 |
| 11/739080 | 7322679 | 11/768875 | 11/779847 | 11/829940 | 11847240 | 11/834625 |
| 11/863210 | 11/865680 | 11/874156 | 11/923602 | 11951940 | 11954988 | 11961662 |
| 12015178 | 12015157 | 12/017305 | 12017926 | 12015261 | 12025605 | 12031646 |
| 7067067 | 6776476 | 6880914 | 7086709 | 6783217 | 7147791 | 6929352 |
| 7144095 | 6820974 | 6918647 | 6984016 | 7192125 | 6824251 | 6834939 |
| 6840600 | 6786573 | 7144519 | 6799835 | 6959975 | 6959974 | 7021740 |
| 6935718 | 6938983 | 6938991 | 7226145 | 7140719 | 6988788 | 7022250 |
| 6929350 | 7011393 | 7004566 | 7175097 | 6948799 | 7143944 | 7310157 |
| 7029100 | 6957811 | 7073724 | 7055933 | 7077490 | 7055940 | 10/991402 |
| 7234645 | 7032999 | 7066576 | 7229150 | 7086728 | 7246879 | 7284825 |
| 7140718 | 7284817 | 7144098 | 7044577 | 7284824 | 7284827 | 7189334 |
| 7055935 | 7152860 | 11/203188 | 11/203173 | 7334868 | 7213989 | 11/225156 |
| 11/225173 | 7300141 | 7114868 | 7168796 | 7159967 | 7328966 | 7152805 |
| 11/298530 | 11/330061 | 7133799 | 11/330054 | 11/329284 | 7152956 | 7128399 |
| 7147305 | 7287702 | 7325904 | 7246884 | 7152960 | 11/442125 | 11/454901 |
| 11/442134 | 11/450441 | 11/474274 | 11/499741 | 7270399 | 6857728 | 6857729 |
| 6857730 | 6989292 | 7126216 | 6977189 | 6982189 | 7173332 | 7026176 |
| 6979599 | 6812062 | 6886751 | 10/804057 | 10/804036 | 7001793 | 6866369 |
| 6946743 | 7322675 | 6886918 | 7059720 | 7306305 | 10/846562 | 7334855 |
| 10/846649 | 10/846627 | 6951390 | 6981765 | 6789881 | 6802592 | 7029097 |
| 6799836 | 7048352 | 7182267 | 7025279 | 6857571 | 6817539 | 6830198 |
| 6992791 | 7038809 | 6980323 | 7148992 | 7139091 | 6947173 | 7101034 |
| 6969144 | 6942319 | 6827427 | 6984021 | 6984022 | 6869167 | 6918542 |
| 7007852 | 6899420 | 6918665 | 6997625 | 6988840 | 6984080 | 6845978 |
| 6848687 | 6840512 | 6863365 | 7204582 | 6921150 | 7128396 | 6913347 |
| 7008819 | 6935736 | 6991317 | 7284836 | 7055947 | 7093928 | 7100834 |
| 7270396 | 7187086 | 7290856 | 7032825 | 7086721 | 7159968 | 7010456 |
| 7147307 | 7111925 | 11/144812 | 7229154 | 11/505849 | 11/520570 | 7328994 |
| 7341672 | 11/540575 | 11/583937 | 7278711 | 7290720 | 7314266 | 11/635489 |
| 11/604319 | 11/635490 | 11/635525 | 7287706 | 11/706366 | 11/706310 | 11/706308 |
| 11/785108 | 11/744214 | 11744218 | 11748485 | 11/748490 | 11/764778 | 11/766025 |
| 11/834635 | 11839541 | 11860420 | 11/865693 | 11/863118 | 11/866307 | 11/866340 |
| 11/869684 | 11/869722 | 11/869694 | 11/876592 | 11/945244 | 11951121 | 11/945238 |
| 11955358 | 11965710 | 11962050 | 12015478 | 12015423 | 12015434 | 12023015 |
| 12030755 | 12025641 | 12036279 | 12031598 | | | |

### BACKGROUND OF THE INVENTION

The Applicant has developed a wide range of printers that employ pagewidth printheads instead of traditional reciprocating printhead designs. Pagewidth designs increase print speeds as the printhead does not traverse back and forth across the page to deposit a line of an image. The pagewidth printhead simply deposits the ink on the media as it moves past at high speeds. Such printheads have made it possible to perform full colour 1600 dpi printing at speeds in the vicinity of 60 pages per minute; speeds previously unattainable with conventional inkjet printers.

Printing at these speeds consumes ink quickly and this gives rise to problems with supplying the printhead with enough ink. Not only are the flow rates higher but distributing the ink along the entire length of a pagewidth printhead is more complex than feeding ink to a relatively small reciprocating printhead.

The ink conduits can be blocked by air bubbles. Air bubbles can form in the ink conduits when dissolved gasses come out of solution during periods of inactivity. If the bubble is big enough, it can completely occlude the conduit and block the ink flow. The bubble can pin to the inside of the conduit such that it requires a finite force to be applied to move it, as if it had a static coefficient of friction. The bubble resists moving with the ink flow and can starve areas downstream of the bubble, or cause a detrimental pressure increase upstream of the bubble.

### SUMMARY OF THE INVENTION

According to a first aspect, the present invention provides an inkjet printer comprising:

a printhead with an array of nozzles for ejecting printing fluid;

a conduit connected to the printhead, the conduit defining a flow path for the printing fluid; wherein,

the conduit has an internal cross section configured such that the surface tension of the printing fluid favors gas bubble growth along the conduit length over radial bubble growth that fully occludes the flow path.

The invention is predicated on the realization that the inherent tendency for surface tension to adopt the lowest energy configuration can be used make gas bubbles grow longitudinally in the ink line instead of radially. By preventing the bubble from growing across the entire flow path, it may constrict the flow but not form a blockage. Ink can still flow through the line without first having to overcome the resistance of a bubble surface tension pinned to the internal surface. Importantly, this allows the pressure on either side of the bubble to equalize during printer standby periods. A pressure build up in the printhead because of diurnal temperature changes can flood the nozzles.

Preferably the internal cross section has a first area and the second area adjoining the first area, the first area being defined as an area that will allow radial growth of the gas bubble until it is completely occluded, and second area being defined as an area that will resist radial intrusion of a gas bubble that completely occludes the first area. Preferably, the second area is shaped such that any gas bubble capable of expanding radially from the first area into the second area until the second area is void of printing fluid, would require an internal gas pressure greater than the internal gas pressure of gas bubbles formed in the printing fluid by outgassing.

Preferably, the internal cross section is star-shaped. Preferably, the internal cross section is triangular. Preferably, the internal cross section is ‘T’-shaped. Preferably, the internal cross section is cross-shaped. Preferably, the internal cross section is ‘three leaf clover’-shaped. In another preferred form, the internal cross section is “four leaf clover”-shaped.

According to a second aspect, the present invention provides an inkjet printer comprising:

a printhead with an array of nozzles for ejecting printing fluid;

a conduit connected to the printhead, the conduit defining a flow path for the printing fluid; wherein,

the conduit has an internal cross section configured such that its dimension in a first direction far exceeds its dimension in the second direction normal to the first direction such that the gas bubble growing within the conduit will break into smaller separate gas bubbles before the fluid includes the flow path because of Plateau-Rayleigh instability.

This aspect of the invention recognises that the phenomenon known as Plateau-Rayleigh instability (named after Joseph Plateau and Lord Rayleigh who investigated the phenomenon in 1873) can be used to ensure that a single gas bubble is not completely occlude the flow path defined by a conduit.

Preferably, the cross section of the conduit is an elongate rectangle. Optionally, the cross section of the printhead can have several intersecting, elongate rectangle sections. In another preferred form, the cross section of the conduit is annular such that the radial width of the conduit is far less than the circumference.

In a particularly preferred form, the printing fluid reservoir is a sump positioned at a lower elevation than the printhead, the sump having a headspace of air above the printing fluid, and an inlet located in the headspace, the conduit being connected to the inlet such that during printer standby periods, the printing fluid in the conduit hanging from the printhead creates negative hydrostatic pressure in the printhead.

The high print speeds require a large ink supply flow rate. This mass of ink is moving relatively quickly through the supply line. Abruptly ending a print job, or simply at the end of a printed page, means that this relatively high volume of ink that is flowing relatively quickly must also come to an immediate stop. However, suddenly arresting the ink momentum gives rise to a pressure pulse in the ink line. The components making up the printhead are typically stiff and provide almost no flex as the column of ink in the line is brought to rest. Without any compliance in the ink line, the pressure spike can exceed the Laplace pressure (the pressure provided by the surface tension of the ink at the nozzles openings to retain ink in the nozzle chambers) and flood the front surface of the printhead nozzles. If the nozzles flood, ink may not eject and artifacts appear in the printing.

The Applicant has addressed these issues by incorporating non-priming cavities into the printhead. A detailed description of the non-priming cavities is provided in the Applicant's co-pending U.S. Ser. No. ______ (our docket RRE001US), the contents of which is incorporated herein by reference. Briefly, the stiff structures that define the ink line have air pockets distributed long the length of the printhead. A pressure pulse in the ink will compress the air in the cavity as it passes that point in the ink line. Compressing the air in the cavity damps and dissipates the pressure pulse to avoid nozzle flooding.

During standby periods when the printer is not operating for an extended time, temperature variations cause the air in the non-priming cavities to expand and contract. The ‘hanging’ column of ink in the downstream line to the sump keeps the printhead at a negative pressure so air expansion does not cause ink to flood from the nozzles. However, a bubble occlusion in the downstream ink line can create a blockage strong enough to prevent the hanging column of ink from accommodating the air expansion during diurnal temperature variations. Instead, the expanding air pockets pump ink out of the nozzles. The resulting flood on the nozzle face can cause color mixing and must be rectified before printing can commence.

Using a conduit according to the present invention, prevents any outgassing bubbles from completely occluding the ink flow path. As the outgassing bubbles do not form a flow obstruction, there is no build up pressure on the upstream side of bubble. Any expansion of the air in the air pockets pumps ink into the sump instead of causing a nozzle flood. Furthermore, the hanging column of ink maintains the correct negative pressure at the nozzles.

### BRIEF DESCRIPTION OF THE DRAWINGS

The invention will now be described by way of example only with reference to the preferred embodiments shown in the accompanying drawings, in which:

FIG. 1 is a schematic diagram of a printer fluidic system;

FIGS. 2A and 2B are schematic transverse and longitudinal cross sections of a conduit during bubble nucleation;

FIGS. 3A and 3B are schematic transverse and longitudinal cross sections of the conduit showing maximum radial bubble growth;

FIG. 4 is a sketch of a star-shaped cross section conduit;

FIG. 5 is a sketch of a triangular cross section conduit;

FIG. 6 is a sketch of a T-shaped cross section conduit;

FIG. 7 is a sketch of a ‘three leaf clover’ cross section conduit;

FIG. 8 is a sketch of a ‘four leaf clover’ cross section conduit;

FIGS. 9A to 9C are sketches of bubble growth within a conduit according to a second aspect of the invention; and,

FIG. 10 is another embodiment of a conduit according to a second aspect of the present invention.

### DETAILED DESCRIPTION OF THE PREFERRED EMBODIMENTS

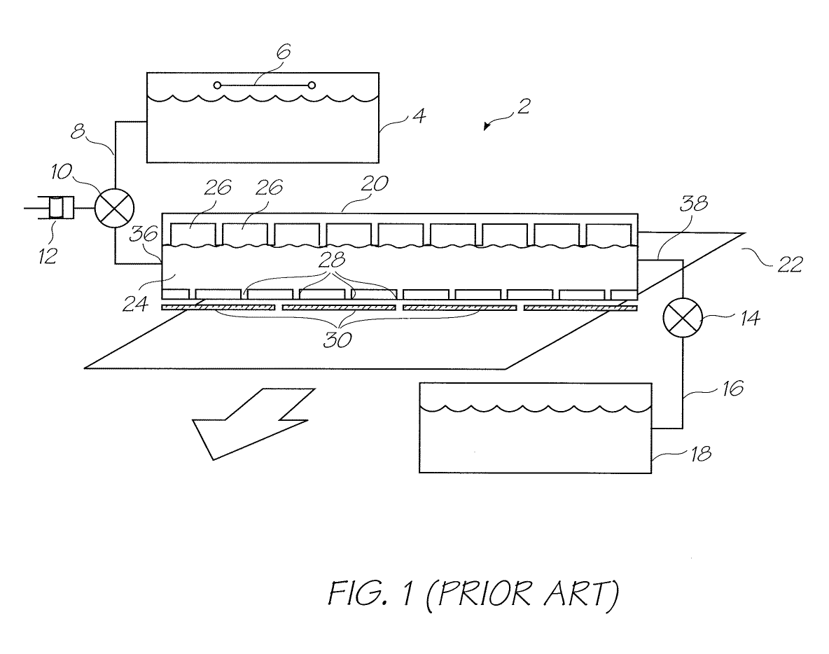

FIG. 1 is a schematic view of a prior art fluidic system of the type used in the above referenced U.S. Ser. No. 11/688863 (Docket No. RRE001US). The operation of the system and its individual components are described in detail in U.S. Ser. No. 11/872719 (Docket No. SBF009US) the contents of which are incorporated herein by reference.

Briefly, the printer fluidic system has a printhead assembly 2 supplied with ink from an ink tank 4 via an upstream ink line 8 and waste ink is drained to a sump 18 via a downstream ink line 16. The downstream ink line 16 has a shut off valve 14 which allows the fluidic system to purge the nozzles to correct colour mixing or recover clogged nozzles.

A single ink line is shown for simplicity. In reality, the printhead has multiple ink lines for full colour printing. The upstream ink line 8 has a shut off valve 10 for selectively isolating the printhead assembly 2 from the pump 12 and or the ink tank 4. The pump 12 is used to actively prime or flood the printhead assembly 2. The pump 12 is also used to establish a negative pressure in the ink tank 4. During printing, the negative pressure is maintained by the bubble point regulator 6.

The printhead assembly 2 is an LCP (liquid crystal polymer) molding 20 supporting a series of printhead ICs 30 secured with an adhesive die attach film (not shown). The printhead ICs 30 have an array of ink ejection nozzles for ejecting drops of ink onto the passing media substrate 22. The nozzles are MEMS (micro electromechanical) structures printing at true 1600 dpi resolution (that is, a nozzle pitch of 1600 npi), or greater. The fabrication and structure of suitable printhead IC's 30 are described in detail in U.S. Ser. No. 11/246687 (Docket No. MNN001US) the contents of which are incorporated by reference. The LCP molding 20 has a main channel 24 extending between the inlet 36 and the outlet 38. The main channel 24 feeds a series of fine channels 28 extending to the underside of the LCP molding 20. The fine channels 28 supply ink to the printhead ICs 30 through laser ablated holes in the die attach film.

Above the main channel 24 is a series of non-priming air cavities 26. These cavities 26 are designed to trap a pocket of air during printhead priming. The air pockets give the system some compliance to absorb and damp pressure spikes or hydraulic shocks in the ink. The printers are high speed pagewidth printers with a large number of nozzles firing rapidly. This consumes ink at a fast rate and suddenly ending a print job, or even just the end of a page, means that a column of ink moving towards (and through) the printhead assembly 2 must be brought to rest almost instantaneously. Without the compliance provided by the air cavities 26, the momentum of the ink would flood the nozzles in the printhead ICs 30. Furthermore, the subsequent ‘reflected wave’ can generate a negative pressure strong enough to deprime the nozzles.

As discussed above, temperature variations cause the air in the non-priming cavities to expand and contract. This can be problematic during standby periods when the printer is not operating for an extended time. The ‘hanging’ column of ink in the downstream line 16 to the sump 18 keeps the printhead 2 at a negative pressure so air expansion does not cause ink to flood from the nozzles 30. However, a bubble occlusion in the downstream ink line 16 can create a blockage strong enough to prevent the hanging column of ink from accommodating the air expansion during diurnal temperature variations. Instead, the expanding air pockets pump ink out of the nozzles. The resulting flood on the nozzle face can cause color mixing and must be rectified before printing can commence.

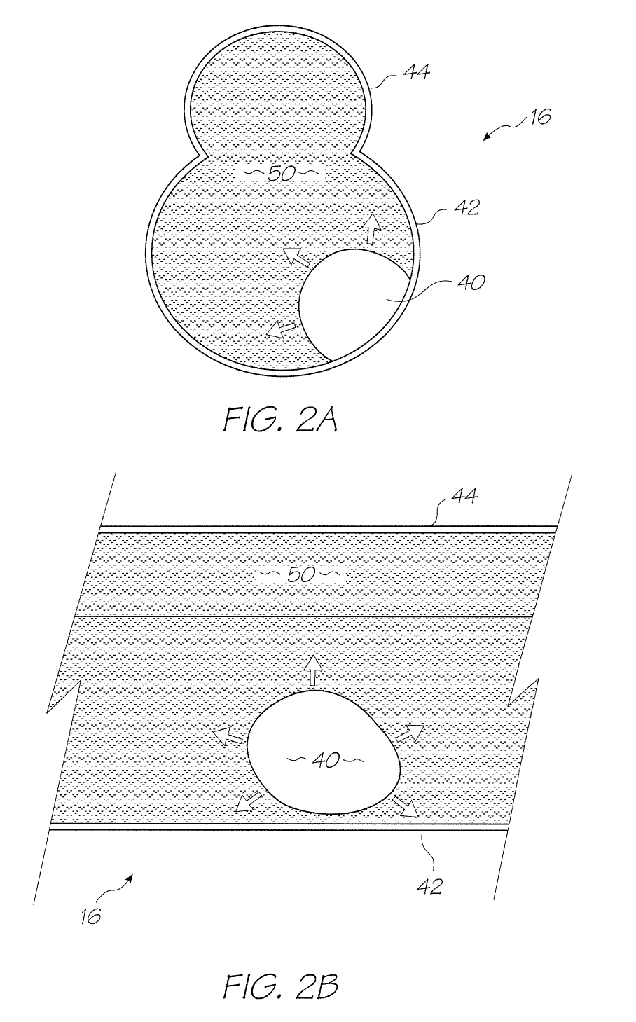

This can be rectified using a conduit according to the present invention of the downstream ink line 16. FIGS. 2A and 2B are sketches of the transverse and longitudinal cross sections of the conduit 16. The cross section of the conduit 16 has two areas-the first area 42 and a second area 44. Both the first and second areas 42 and 44 defining a flow path for the ink 50. Outgassing bubble 40 nucleates on the side of the first area 42 and expands radially and longitudinally.

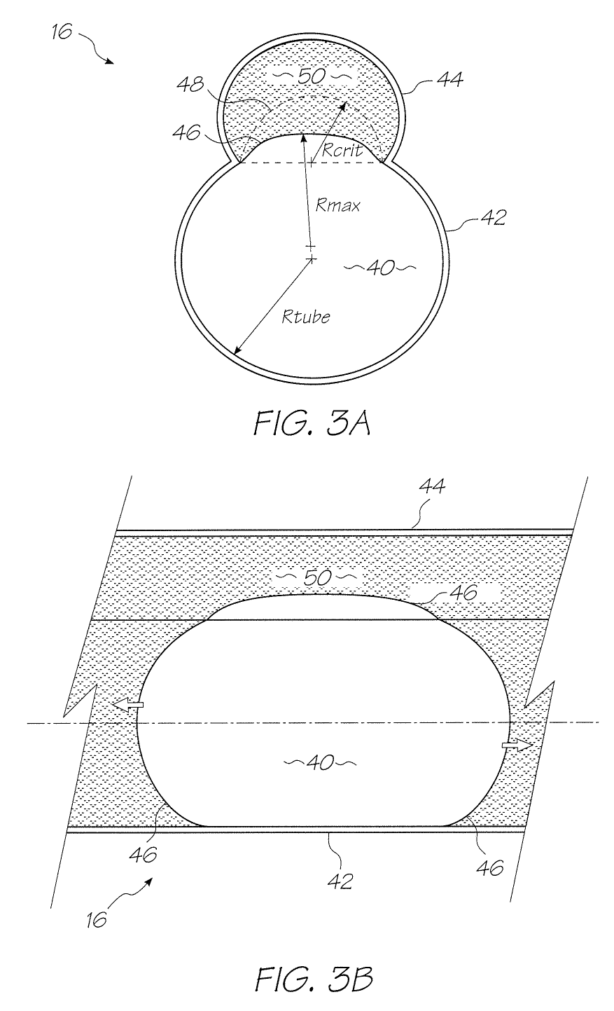

In FIGS. 3A and 3B, the outgassing bubble 40 has grown to completely occlude the first area 42. However the second area 44 remains filled with ink 50. The shape of the outgassing bubble 40 is defined by the radius R_{tube} of the first area 42 and the maximum possible radius Rₘₐₓ at the unconstrained face 46 of the bubble 40. The unconstrained face 46 of the bubble 40 will naturally tend towards the lowest energy state. Accordingly the radius of curvature Rₘₐₓ of the unconstrained face 46 will be the maximum that the gas pressure within the bubble 40 will allow (which corresponds to the minimum surface area that the bubble face 46 can have at the gas pressure). With increasing gas pressure, the radius of the bubble face 46 reduces, and the surface area of the bubble face 46 increases.

In order for the bubble 40 to continue growing into the second area 44 and eventually occluding it, the gas pressure within the bubble 40 would need to be enough to form a semicircular bubble surface 48 having a critical radius of curvature R_{crit}. Knowing the internal gas pressure of outgassing bubbles 40, the first area 42 and the second area 44 can adjoin each other such a way that Rₘₐₓ of any bubble surface 46 formed during the expected range of ambient conditions is greater than R_{crit}. This will prevent any bubble 40 nucleating is the first area 42 from continuing to grow radially into the second area 44. Instead further bubble roof will be in the longitudinal direction of the first area 42 (see FIG. 3B). In this way the ink 50 always has a flow path around the bubble 40.

The ordinary worker will appreciate that the second area 44 can also the configured such that an outgassing bubble 40 nucleating on its inner wall will never grow large enough to occlude the first area 42. Furthermore, once the printer has come out of standby mode as strong flow of ink from the printhead assembly 2 (see FIG. 1) to the sump 18 will clear the downstream ink line 16 of the outgassing bubbles 40.

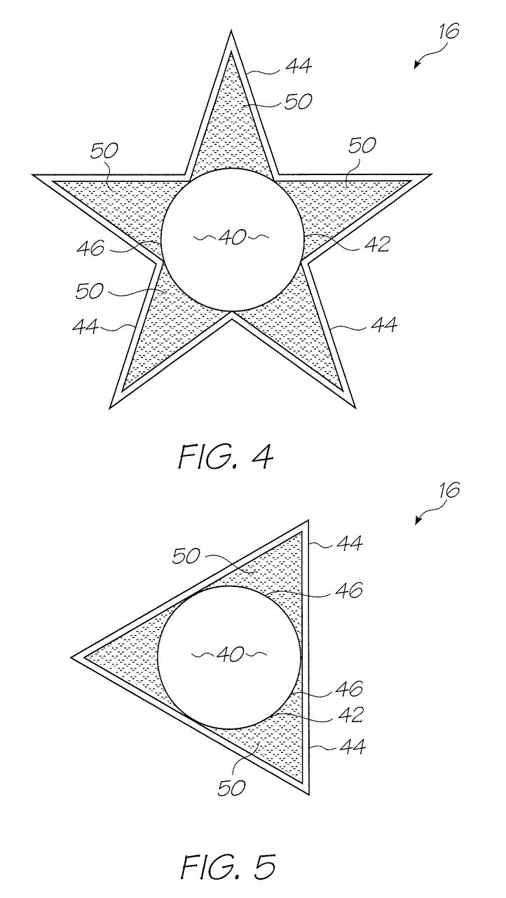

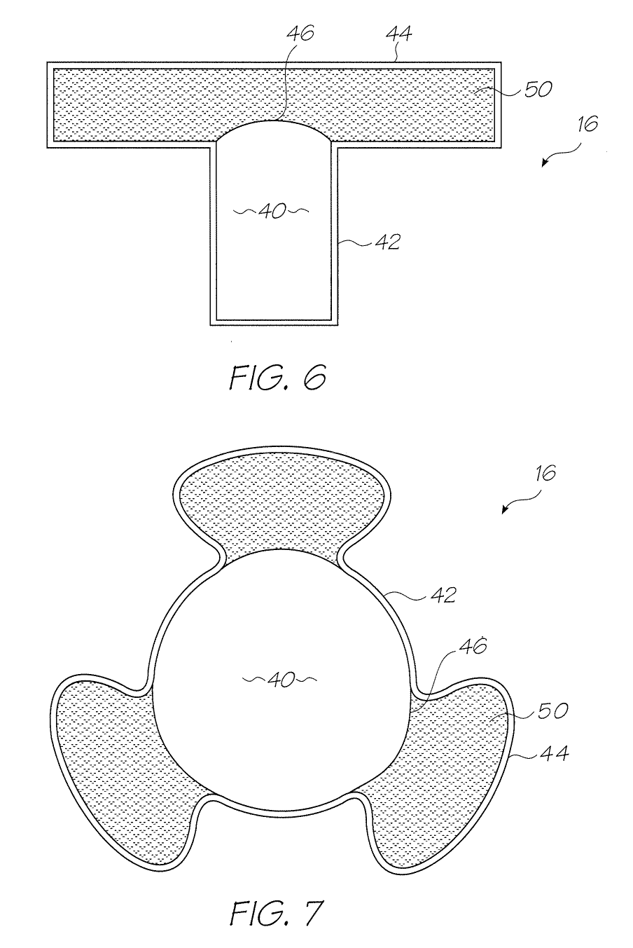

FIGS. 4 to 8 are sketches of possible cross sections of the conduit 16. FIG. 4 shows a star-shaped cross section with a central for defining the first area 42 while the points of the star provide a plurality of second areas 44. An outgassing bubble 40 in the first area 42 will not continue to grow radially into the points 44. Instead, further bubble growth will be longitudinal. In this embodiment, if the outgassing bubble 40 nucleates in one of the points 44 of the star, then bubble growth may extend further into that point than any of the others. However, the remainder of the points will provide a flow path for the ink 50.

Similarly, the triangular cross section shown in FIG. 5 will contain any outgassing bubbles 40 in a central area 42 while vertices 44 of the triangle remains filled with ink 50. In figure six, the cross section is T-shaped. Bubble 40 growth and occlusion in one section 42 of the ‘T’ will not extend into the other section 44 of the ‘T’.

FIGS. 7 and 8 show cross sections having a three leaf and four leaf clover shape respectively. These cross sections are particularly useful when applied to extruded, flexible tubing. Not only do the leafs 44 have a relatively large surface area to provide little resistance to any flow of ink 50 when central bore 42 is occluded by a bubble 40, but the clover shape is resistant to kinking in a way that blocks all fluid flow.

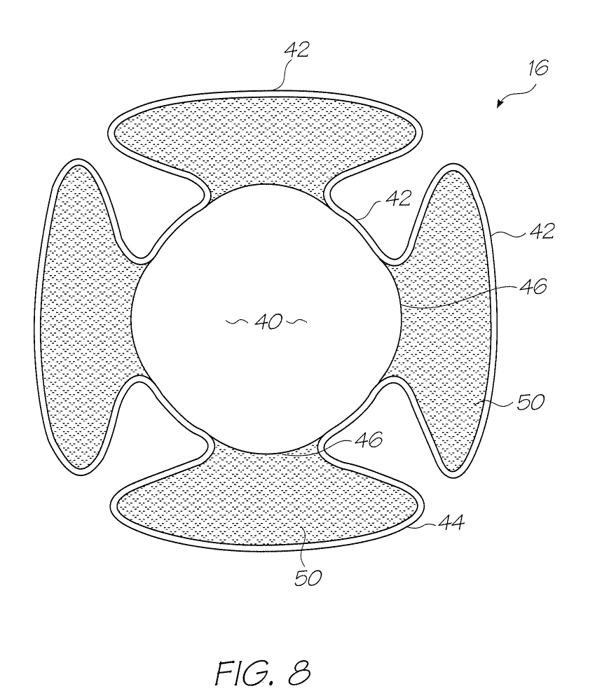

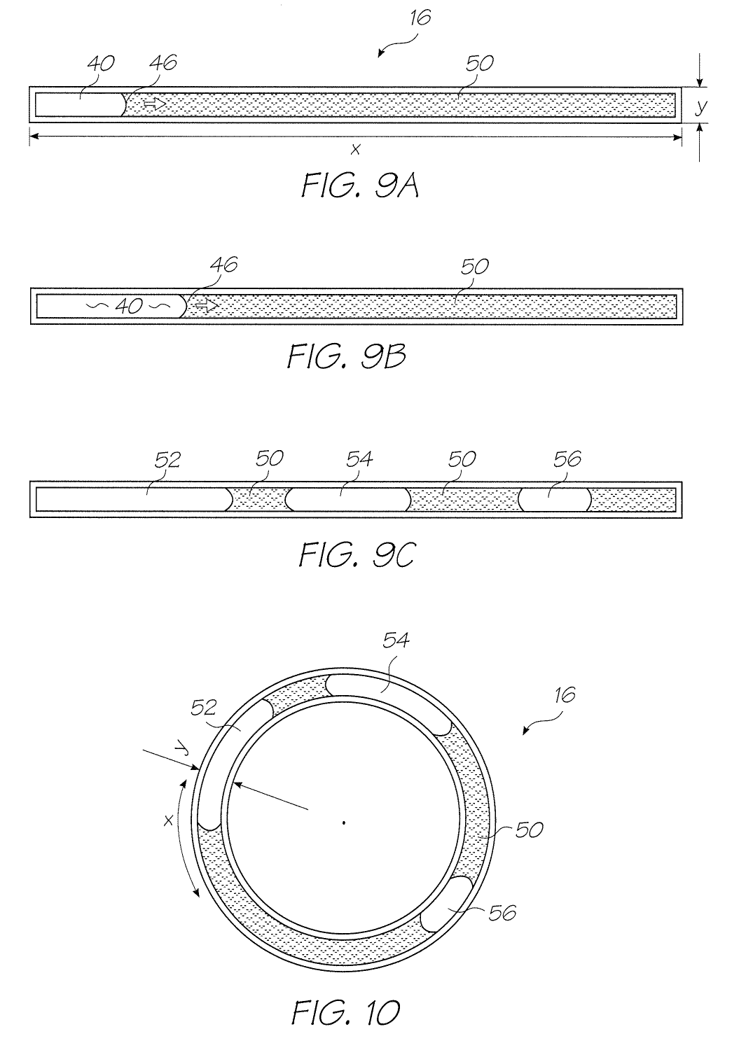

FIGS. 9A, 9B and 9C show the cross sections of conduit 16 according to the second aspect of the invention. These cross sections extend into one dimension X for more than the transverse dimension Y. If an outgassing bubble 40 nucleates in conduit 16 it will grow as a single bubble 40 in the X direction. However before the bubble 40 can extend completely across the conduit 16, a phenomenon known as the Plateau Rayleigh instability will cause the bubble 40 to break up into separate bubbles 52, 54 and 56 (the FIG. 9C). This will ensure that the cross sections is never completely occluded and the ink 50 has flow path between an around the individual bubbles.

Optionally, FIG. 10 shows the cross section of an annular conduit 16. The circumference X of the annulus is far greater than the width Y of the annual flow path. Once again, any single outgassing bubbles will eventually become unstable and split into individual bubbles 52, 54 and 56. Between these bubbles, the ink 50 maintains a flow path.

The present invention has been described herein by way of example only. Skilled workers in this field will readily recognise many variations and modifications which do not depart from the spirit and scope of the broad inventive concept.

1. An inkjet printer comprising:
a printhead with an array of nozzles for ejecting printing fluid;
a conduit connected to the printhead, the conduit defining a flow path for the printing fluid; wherein,
the conduit has an internal cross section configured such that the surface tension of the printing fluid favors gas bubble growth along the conduit length over radial bubble growth that would fully occlude the flow path.

2. An inkjet printer according to claim 1 wherein the internal cross section has a first area and the second area adjoining the first area, the first area being defined as an area that will allow radial growth of the gas bubble until it is completely occluded, and second area being defined as an area that will resist radial intrusion of a gas bubble that completely occludes the first area.

3. An inkjet printer according to claim 2 wherein the second area is shaped such that any gas bubble capable of expanding radially from the first area into the second area until the second area is void of printing fluid, would require an internal gas pressure greater than the internal gas pressure of gas bubbles formed in the printing fluid by outgassing.

4. An inkjet printer according to claim 1 wherein the internal cross section is star-shaped.

5. An inkjet printer according to claim 1 wherein the internal cross section is triangular.

6. An inkjet printer according to claim 1 wherein the internal cross section is ‘T’-shaped.

7. An inkjet printer according to claim 1 wherein the internal cross section is cross-shaped.

8. An inkjet printer according to claim 1 wherein the internal cross section is ‘three leaf clover’-shaped.

9. An inkjet printer according to claim 1 wherein the internal cross section is “four leaf clover”-shaped.

10. An inkjet printer according to claim 1 wherein the flow path extends between the printhead and a printing fluid reservoir.

11. An inkjet printer according to claim 10 wherein the printing fluid reservoir is a sump positioned at a lower elevation than the printhead, the sump having a headspace of air above the printing fluid, and an inlet located in the headspace, the conduit being connected to the inlet such that during printer standby periods, the printing fluid in the conduit hanging from the printhead creates negative hydrostatic pressure in the printhead.

12. An inkjet printer comprising:
a printhead with an array of nozzles for ejecting printing fluid;
a conduit connected to the printhead, the conduit defining a flow path for the printing fluid; wherein,
the conduit has an internal cross section configured such that its dimension in a first direction far exceeds its dimension in the second direction normal to the first direction such that the gas bubble growing within the conduit will break into smaller separate gas bubbles because of Plateau-Rayleigh instability, before the gas bubble can occlude the flow path.

13. An inkjet printer according to claim 12 wherein the cross section of the conduit is an elongate rectangle.

14. An inkjet printer according to claim 12 wherein the cross section of the conduit has several intersecting, elongate rectangle sections.

15. An inkjet printer according to claim 12 wherein the cross section of the conduit is annular such that the radial width of the conduit is far less than the circumference.

16. An inkjet printer according to claim 12 wherein the flow path extends between the printhead and a printing fluid reservoir.

17. An inkjet printer according to claim 16 wherein the printing fluid reservoir is a sump positioned at a lower elevation than the printhead, the sump having a headspace of air above the printing fluid, and an inlet located in the headspace, the conduit being connected to the inlet such that during printer standby periods, the printing fluid in the conduit hanging from the printhead creates negative hydrostatic pressure in the printhead.
